(19) United States
(12) Patent Application Publication
(10) Pub. No.: US 2026/0147303 A1
(43) Pub. Date: May 28, 2026

(54) IMAGE FORMING APPARATUS

(71) Applicant: CANON KABUSHIKI KAISHA, Tokyo (JP)

(72) Inventor: YUYA KONNO, Shizuoka (JP)

(21) Appl. No.: 19/388,447

(22) Filed: Nov. 13, 2025

(30) Foreign Application Priority Data
Nov. 25, 2024 (JP) 2024-204596

(51) Int. Cl. G03G 15/00; G06K 15/00; G06K 15/02; G06K 15/16

(52) U.S. Cl. CPC G03G 15/6564; G03G 15/5029; G03G 15/70; G06K 15/16; G06K 15/1885; G06K 15/4085; G03G 2215/00599; G03G 2215/00734; G03G 2215/00759

(57) ABSTRACT

An image forming apparatus includes a controller that outputs image information, an image forming unit that forms an image on paper based on the image information output from the controller, a conveyance unit that conveys the paper to the image forming unit, and a speed correction unit that corrects speed of conveyance of the paper by the conveyance unit based on information regarding an expansion and contraction amount of the image.

### BACKGROUND

### Field of the Technology

The present disclosure relates to an image forming apparatus using electrophotography.

### Description of the Related Art

An image forming apparatus, such as a printer, a copy machine, or a facsimile, is conventionally capable of printing an image on a ledger sheet and pre-printed paper on which a corporate name, a logo mark, or the like is preliminarily printed. In a case where an image is printed on pre-printed paper, a print image needs to be formed with high positional accuracy with respect to a pre-printed image. Thus, a user fine-adjusts a layout of the print image so that the print image is printed at a target position of the pre-printed paper.

Even in a case where an instruction for printing an identical image is provided, there may be a case where an image expansion and contraction amount differs slightly depending on an image forming apparatus. For example, in a case where the image forming apparatus to be used is replaced, an image expansion and contraction amount in a conveyance direction of a print image may be changed. In this case, there is a possibility that a print position of a pre-printed image and that of the print image are slightly shifted from each other.

U.S. Patent Application Laid-Open No. 2010/0189451 describes an image forming apparatus that adjusts rotational speed of a polygon mirror in a laser scanner unit to change an expansion and contraction amount of an image to be printed on paper.

According to U.S. Patent Application Laid-Open No. 2010/0189451, the image forming apparatus adjusts the rotational speed of the polygon mirror in the laser scanner unit to change the image expansion and contraction amount, but there is a possibility of degradation of image quality depending on a hardware configuration of the laser scanner unit. Additionally, as another means of suppressing a shift in print position between the pre-printed image and the print image, the following unit can also be considered. That is, there is a means of using a controller on a printer side to enlarge or reduce data of an image instructed to be printed by a printer and thereby suppress a shift in print position of the image. In a case where such a means is employed, there is a possibility that a load on the controller increases and it takes time to perform image processing, resulting in reduced productivity.

### SUMMARY

The present disclosure is directed to an image forming apparatus that prints an image with high positional accuracy while suppressing the reduction of productivity.

According to an aspect of the present disclosure, an image forming apparatus includes a controller configured to output image information, an image forming unit configured to form an image on paper based on the image information output from the controller, a conveyance unit configured to convey the paper to the image forming unit, and a speed correction unit configured to correct speed of conveyance of the paper by the conveyance unit based on information regarding an expansion and contraction amount of the image.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view illustrating an image forming apparatus according to a first embodiment.

FIG. 2 is a diagram illustrating a hardware configuration of the image forming apparatus according to the first embodiment.

FIG. 3 illustrates a control block diagram according to the first embodiment.

FIG. 4 is a flowchart illustrating control according to the first embodiment.

FIG. 5 is a cross-sectional view illustrating an image forming apparatus according to a second embodiment.

FIG. 6 is a diagram illustrating a hardware configuration of a post-processing apparatus according to the second embodiment.

FIG. 7 illustrates a control block diagram according to the second embodiment.

FIG. 8 is a flowchart illustrating control according to the second embodiment.

### DESCRIPTION OF THE EMBODIMENTS

Embodiments will be described in detail below with reference to the accompanying drawings. The following embodiments do not limit the scope of the claims. While a plurality of features is described in the embodiments, not all combinations of these features are necessarily essential to the present disclosure, and these features may be freely combined. In the accompanying drawings, identical or similar components are denoted by an identical reference number, and an overlapping description is omitted.

### First Embodiment

### <Image Forming Process>

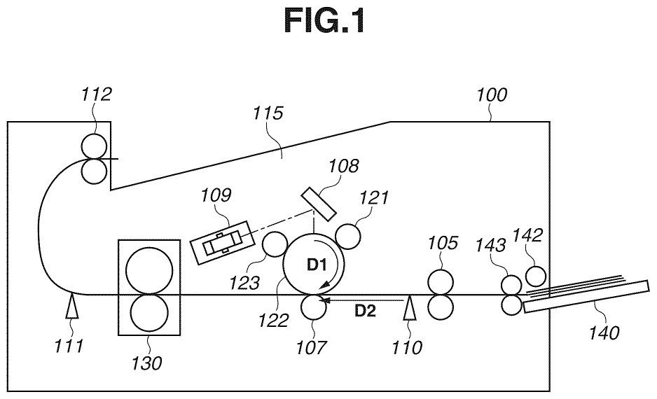

FIG. 1 is a view schematically illustrating a configuration of a printer 100 as an example of an image processing apparatus. In FIG. 1, the printer 100 includes the following elements as elements of an image forming unit that forms an image on paper. A photosensitive drum 122 is an image bearing member composed of an organic photosensitive member or an amorphous silicon photosensitive member, and is rotationally driven in a clockwise direction at predetermined circumferential speed (process speed).

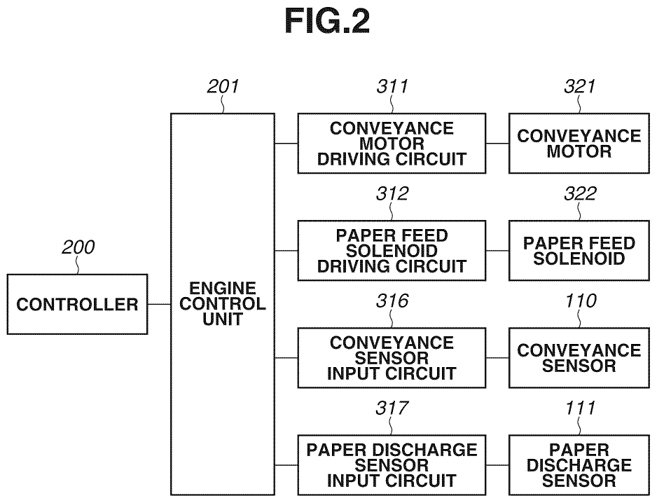

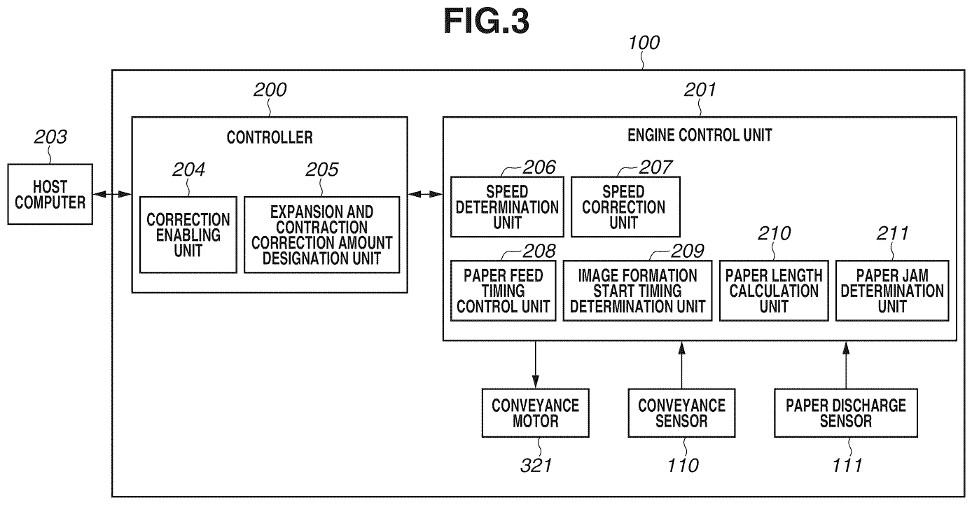

A circumferential surface of the photosensitive drum 122 is uniformly charged by a charging roller 123 to have a predetermined polarity and a predetermined potential. The circumferential surface of the photosensitive drum 122 is irradiated with laser light that is emitted from laser diodes arranged in a laser optical box 109 and that is polarized by a reflection mirror 108. A controller 200 (refer to FIGS. 2 and 3) converts image information transmitted from a host computer 203 (refer to FIG. 3) into time-sequential electric digital pixel signals (hereinafter referred to as video signals). Laser light modulated (converted between ON and OFF) according to the converted pixel signals is emitted, whereby scan exposure is performed. Based on this operation, an electrostatic latent image corresponding to the image information is formed on the circumferential surface of the photosensitive drum 122. The electrostatic latent image formed to correspond to a target image in this manner is developed as a toner image by a developing device 121.

A paper feed roller 142 is a paper feed unit that feeds recording paper placed on a paper feed tray (stacking unit) 140 to separation rollers 143. The separation rollers 143 separate the supplied recording paper into individual sheets, and supply the recording paper to conveyance rollers 105, which are one example of a conveyance unit. The recording paper supplied to the conveyance rollers 105 is conveyed to the photosensitive drum 122. The toner image developed on the photosensitive drum 122 is formed on the recording paper. At this time, a transfer roller 107 applies charge with an opposite polarity to toner from a back side of the recording paper, and thereby transfers the toner image from the photosensitive drum 122 to the recording paper. The recording paper to which the toner image has been transferred in this manner is separated from the photosensitive drum 122 and sent to a fixing device 130 where the toner image is fixed to the recording paper by heat. The recording paper to which the toner image has been fixed by heat is conveyed by paper discharge rollers 112 and discharged to a paper discharge tray 115.

### <Hardware Configuration Diagram>

FIG. 2 is a diagram illustrating a hardware configuration of the printer 100. An engine control unit 201 executes a program stored in a read-only memory (ROM), which is not illustrated, and operates each driving circuit in the image forming unit to control the printer 100. A conveyance motor 321 is a drive unit driven via a conveyance motor driving circuit 311. A paper feed solenoid 322 is switched between ON and OFF via a paper feed solenoid driving circuit 312. The conveyance motor 321 rotationally moves the photosensitive drum 122, the developing device 121, the charging roller 123, the conveyance rollers 105, rollers in the fixing device 130, and the paper discharge rollers 112. The paper feed roller 142 and the separation rollers 143 are driven by the conveyance motor 321, and rotationally move when the paper feed solenoid 322 is turned ON.

A conveyance sensor 110 is a detection unit that detects presence or absence of recording paper on a conveyance path. A result of detection of the presence or absence of paper is transmitted to the engine control unit 201 via a conveyance sensor input circuit 316. A paper discharge sensor 111 detects the presence or absence of the recording paper on the conveyance path. A result of the detection of the presence or absence of paper is transmitted to the engine control unit 201 via a paper discharge sensor input circuit 317.

The controller 200 communicates with the engine control unit 201 via a communication port, which is not illustrated, and outputs image information and other various pieces of information. For example, the controller 200 transmits or receives a size of the recording paper and information regarding a type of the recording paper including a thickness of the recording paper and a basis weight of the recording paper.

### <Control Details>

FIG. 3 illustrates a control block diagram according to the first embodiment. The controller 200 provides a print instruction to the engine control unit 201 based on an instruction from the host computer 203. Specifically, the controller 200 receives image information and a print command from the host computer 203, analyzes the received image information, converts the image information into bit data, and notifies the engine control unit 201 of a print command and video signals for each recording paper. The print command transmitted from the controller 200 includes the information regarding the paper type of the recording paper to be printed and the size of the recording paper. The controller 200 receives, from the user via the host computer 203, an expansion and contraction correction amount at the time of expanding and contracting an image in the conveyance direction and whether to execute correction to expand and contract the image in the conveyance direction in response to the print command instructed from the user. An expansion and contraction correction amount designation unit 205 included in the controller 200 notifies the engine control unit 201 of the expansion and contraction correction amount [%] at the time of expanding and contracting the image, which is received from the user, in the conveyance direction. For example, in a case of performing print on A4 paper with a margin of 5 mm at each of the leading end and the trailing end in the conveyance direction, the printer 100 is supposed to discharge the paper on which the image with a length of 287 mm is printed. In contrast, assume a case where the printer 100 discharges paper on which an image with a margin of merely 4 mm at the trailing end is printed. In other words, assume a case where the printer 100 discharges paper on which the image with a length of 288 mm is printed. In this case, to reduce the image by 1 mm, the expansion and contraction correction amount designation unit 205 notifies the engine control unit 201 of 99.653% (287 mm/288 mm).

A correction enabling unit 204 included in the controller 200 notifies the engine control unit 201 of information indicating whether to execute expansion and contraction correction, which is received from the user. The engine control unit 201 performs an image forming process based on the print command, the expansion and contraction correction amount, and the information indicating whether to execute correction, which are received from the controller 200.

A speed determination unit 206 determines speed of conveyance of the recording paper to the image forming unit at start of the image forming process based on the type of the recording paper and the size of the recording paper. For example, in a case where the recording paper is thick paper, the paper absorbs a large amount of heat absorbed by paper in the fixing device 130. To sufficiently fix the toner image by heat, the fixing device 130 needs to fix the recording paper by heat for a long period of time. Thus, in a case of thick paper, the speed determination unit 206 reduces conveyance speed in comparison with that of plain paper. The speed determination unit 206 switches conveyance speed depending on a paper width. The heat emitted from the fixing device 130 is absorbed by the paper via the rollers in the fixing device 130. The larger the width of the recording paper, the larger the areas of the rollers in the fixing device 130 being in contact with the recording paper. Thus, heat is more easily absorbed by the recording paper. The smaller the width of the recording paper, the smaller the areas of the rollers in the fixing device 130 being in contact with the recording paper. Thus, heat is poorly absorbed by the recording paper. As a result, as the recording paper has a smaller width, it is more likely heat is accumulated in the rollers. To prevent a harmful effect due to excessive accumulation of heat in the rollers, in a case where the paper width is too small, the engine control unit 201 reduces an amount of heating of the fixing device 130. For the fixing device 130 to sufficiently fix the toner image by heat even in the reduced amount, in a case of a small paper width, the speed determination unit 206 decreases the conveyance speed.

In a case where the recording paper has a basis weight of 80 g/cm² or less and a paper width of 180 mm or more, the speed determination unit 206 sets the conveyance speed at 300 mm/s. In a case where none of the above applies, the speed determination unit 206 sets the conveyance speed at 200 mm/s.

A speed correction unit 207 corrects the conveyance speed determined by the speed determination unit 206 based on the information regarding the image expansion and contraction amount notified by the expansion and contraction correction amount designation unit 205. For example, in a case where the speed determination unit 206 determines the conveyance speed to be 300 mm/s, and the speed correction unit 207 is notified of 99 [%] by the expansion and contraction correction amount designation unit 205, the speed correction unit 207 corrects the conveyance speed to 297 mm/s. In this case, the engine control unit 201 conveys the paper at 297 mm/s during a print operation. In the present embodiment, the image expansion and contraction amount is notified in units of [%], but information regarding the expansion and contraction amount may be notified in units of [mm].

A paper feed timing control unit 208 turns ON the paper feed solenoid 322 at a target time interval. For example, in a case where the printer 100 according to the present embodiment performs continuous print, it is necessary to set a paper interval of 30 mm or more due to the shape of the conveyance sensor 110. Thus, in a case of continuous print on paper with a paper length of 270 mm, the paper feed timing control unit 208 turns ON the paper feed solenoid 322 every time the paper is conveyed by 300 mm. Assuming that the conveyance speed is 300 mm/s, the paper feed timing control unit 208 turns ON the paper feed solenoid 322 every 1000 ms.

An image formation start timing determination unit 209 instructs the start of transmitting video signals to the controller 200 at a predetermined timing so that the leading end of an image to be printed by the printer 100 and the position of the leading end of the conveyed paper are matched. The instruction corresponds to an image formation start timing. For example, assume that a distance, which is indicated by D1 in FIG. 1, between a position at which the photosensitive drum 122 is irradiated with laser light output from the laser optical box 109 and a nip position between the photosensitive drum 122 and the transfer roller 107 is 97 mm. Also assume that a distance, which is indicated by D2 in FIG. 1, between the conveyance sensor 110 and the nip position between the photosensitive drum 122 and the transfer roller 107 is 100 mm. Since a difference between D2 and D1 is 3 mm in this case, the image formation start timing determination unit 209 instructs the controller 200 to start transmission of video signals at a timing at which the paper is conveyed by 3 mm after a detection state of the conveyance sensor 110 changes from a paper absent state to a paper present state. With this operation, the leading end position of the image to be printed is matched with the leading end position of the paper. Assuming that the conveyance speed is 300 mm/s, the image formation start timing determination unit 209 instructs the controller 200 to start transmission of video signals 10 ms after the conveyance sensor 110 detects the paper.

A paper length calculation unit 210 is a calculation unit that calculates a paper length in the conveyance direction of the paper conveyed to the printer 100. The paper length calculation unit 210 calculates the paper length from a period of time since the detection state of the conveyance sensor 110 changes to the paper present state until the detection state changes to the paper absent state. For example, in a case where the period of time is 900 ms when the printer 100 is performing print at conveyance speed of 300 mm/s, the paper length calculation unit 210 calculates the paper length as 270 mm.

A paper jam determination unit 211 determines whether a paper jam has occurred during the print operation. In a case where a detection state of the paper discharge sensor 111 does not change from a paper absent state to a paper present state with elapse of a predetermined period of time since a timing at which the detection state of the conveyance sensor 110 changes from the paper absent state to the paper present state, the paper jam determination unit 211 determines that the paper jam has occurred. Specifically, in a case where a distance between the conveyance sensor 110 and the paper discharge sensor 111 is 210 mm and the printer 100 is performing print at conveyance speed of 300 mm/s, it is possible to assume that the paper is conveyed in 700 ms between the conveyance sensor 110 and the paper discharge sensor 111. In consideration of a conveyance error or the like, a margin of 10% is added. That is, in a case where the detection state of the paper discharge sensor 111 does not change from the paper absent state to the paper present state with elapse of 770 ms since the timing at which the detection state of the conveyance sensor 110 changes from the paper absent state to the paper present state, the paper jam determination unit 211 determines that the paper jam has occurred.

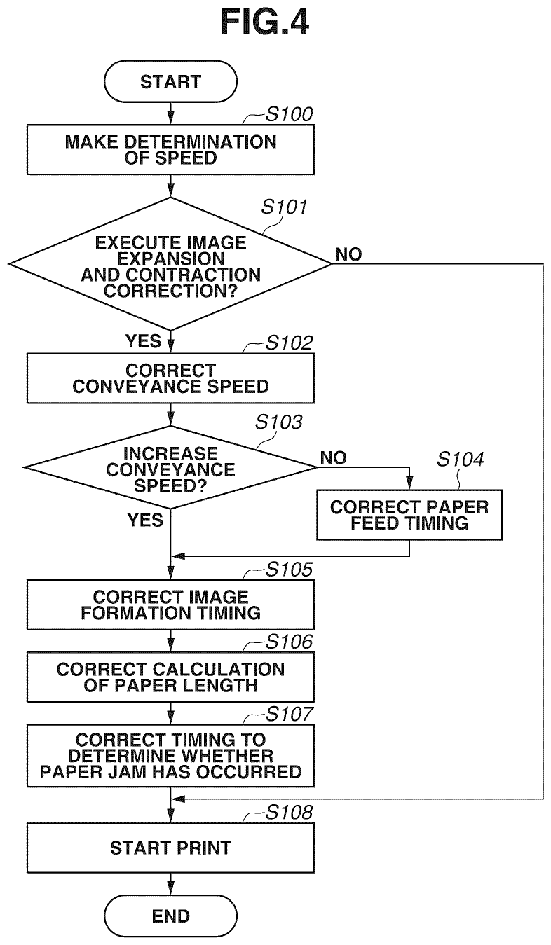

In a case where the image is expanded and contacted in the conveyance direction, the engine control unit 201 performs the following control. When receiving a print instruction from the controller 200, the engine control unit 201 starts the processing illustrated in the flowchart in FIG. 4. Each step in the flowchart in FIG. 4 is executed by the engine control unit 201.

In step S100, the speed determination unit 206 determines a speed of conveyance of the recording paper to the image forming unit based on the type of the recording paper and the size of the recording paper. While details of the determination processing have been described above and are not repeated herein, in a case where print is performed on A4 plain paper as the recording paper, assume that in the present embodiment the conveyance speed is 300 mm/s.

In step S101, the engine control unit 201 determines whether to execute image expansion and contraction correction based on information regarding an image expansion and contraction amount notified together with image information from the controller 200. Specifically, in a case of receiving a notification about disabling the image expansion and contraction correction (that is, a notification about not performing the image expansion and contraction correction) from the correction enabling unit 204 of the controller 200, the engine control unit 201 determines not to execute the image expansion and contraction correction. In a case where the notification received from the expansion and contraction correction amount designation unit 205 indicates 100%, the engine control unit 201 determines not to execute the image expansion and contraction correction. In a case where the engine control unit 201 determines not to execute the image expansion and contraction correction (NO in step S101), the processing proceeds to step S108. Various types of control performed in a case where the engine control unit 201 does not execute the image expansion and contraction correction are as described above.

In a case where the engine control unit 201 determines to execute the image expansion and contraction correction (YES in step S101), the processing proceeds to step S102. In step S102, the speed correction unit 207 corrects the conveyance speed obtained in step S101 based on the information regarding the image expansion and contraction amount notified by the controller 200. For example, in a case where the notification received from the expansion and contraction correction amount designation unit 205 indicates 99%, the speed correction unit 207 corrects the conveyance speed to 297 mm/s, which is 99% of 300 mm/s. The processing then proceeds to step S103.

In step S103, the engine control unit 201 determines whether to perform correction to increase the conveyance speed as speed correction performed in step S102. In a case where the correction is correction to increase the conveying speed (YES in step S103), the engine control unit 201 does not execute paper feed timing correction in step S104 and the processing proceeds to step S105. The reason that the paper feed timing correction is not performed is as follows. That is, in a case where the engine control unit 201 increases the conveyance speed but does not correct the paper feed timing, a sheet-to-sheet distance at the time of continuous print widens in comparison with a case where the engine control unit 201 does not correct the conveyance speed. In a case where the engine control unit 201 advances the paper feed timing to prevent widening of the sheet-to-sheet distance, a sheet-to-sheet time interval shortens. Shortening the sheet-to-sheet time interval causes a shortage of heat accumulated in the fixing device 130 between sheets, which inhibits the fixing device 130 from performing favorable fixing by heat. In a case where the engine control unit 201 determines to increase the conveyance speed (YES in step S103), the paper feed timing control unit 208 does not correct the paper feed timing and the processing proceeds to step S105.

In a case where the engine control unit 201 determines to decrease the conveyance speed (NO in step S103), the processing proceeds to step S104. In step S104, the paper feed timing control unit 208 corrects the paper feed timing so that the sheet-to-sheet distance is at least 30 mm or more. The following description is provided assuming that the notification received from the expansion and contraction correction amount designation unit 205 indicates 99% and the paper length is 270 mm. The paper feed timing control unit 208 corrects the paper feed timing every time the paper is conveyed by 300 mm at 299 mm/s. That is, the paper feed timing control unit 208 changes the paper feed timing to 1003.3 ms.

In step S105, the engine control unit 201 corrects an image formation timing. The image formation start timing determination unit 209 determines a timing to instruct the controller 200 to start transmission of the video signals at the time of print based on the corrected conveyance speed. Specifically, the timing of conveyance of the paper by 3 mm at 299 mm/s, that is, a period of time since the paper is detected by the conveyance sensor 110 until the instruction is provided to the controller 200 to start transmission of the video signals is determined as 10.03 ms. This results in a leading end registration distance from the leading end of the paper to the leading end of the image beings a distance equal to that in a case where the conveyance speed is not corrected (predetermined distance).

The processing then proceeds to step S106. In step S106, the paper length calculation unit 210 corrects an expression for calculating the paper length based on the corrected conveyance speed. That is, in a case where the period of time since the detection state of the conveyance sensor 110 changes to the paper present state until the detection state changes to the paper absent state is 900 ms at the time of print, the paper length calculation unit 210 calculates the paper length as 269.1 mm. Similarly, in a case where the period of time is 903 ms, the paper length calculation unit 210 calculates the paper length as 270 mm. This configuration enables the paper length calculation unit 210 to correctly calculate the paper length even in a case where the speed correction unit 207 corrects the conveyance speed.

Next, the processing proceeds to step S107. In step S107, the paper jam determination unit 211 corrects a timing to determine that the paper jam has occurred at the time of print based on the corrected conveyance speed. Specifically, the paper jam determination unit 211 calculates a period of time to convey the paper by 210 mm, which is the distance between the conveyance sensor 110 and the paper discharge sensor 111, at 299 mm/s, and also adds the margin of 10% to a calculated result to obtain a period of time as the timing to determine that the paper jam has occurred. That is, the paper jam determination unit 211 sets 210 mm/299 mm/s×1.1=772.6 ms as the period of time. Thus, in a case where the detection state of the paper discharge sensor 111 does not change from the paper absent state to the paper present state with elapse of 772.6 ms since the timing at which the detection state of the conveyance sensor 110 changes from the paper absent state to the paper present state, the paper jam determination unit 211 determines that the paper jam has occurred. The processing then proceeds to step S108, where the engine control unit 201 starts a print operation.

When the print operation starts in step S108, the processing of the flowchart in FIG. 4 ends. The engine control unit 201 then rotationally moves the conveyance motor 321 at conveyance speed of 299 mm/s.

As described above, in a case where the controller 200 issues a notification about the information regarding the image expansion and contraction amount, the engine control unit 201 corrects the conveyance speed depending on contents instructed by the correction enabling unit 204 and the expansion and contraction correction amount designation unit 205. This changes the amount of expansion and contraction of the image to be printed in the conveyance direction, which enables reducing a shift in print position between the pre-printed image printed on pre-printed paper and the image to be printed.

According to the present embodiment, the engine control unit 201 executes processing from steps S103 to S107, thus reducing harmful effects due to switching of the conveyance speed.

In the present embodiment, the description has been provided of the configuration in which the expansion and contraction correction amount designation unit 205 provides a notification about the rate [%] when extracting and contracting the image in the conveyance direction. The present disclosure is not limited to this configuration. For example, the expansion and contraction correction amount designation unit 205 may be configured to provide a notification about an expansion and contraction amount [mm]. In this case, the speed correction unit 207 calculates a correction rate [%] of the conveyance speed based on the size of supplied paper or the like and the contents notified by the expansion and contraction correction amount designation unit 205, and corrects the conveyance speed. This configuration results in identical effects to those described above.

The present embodiment provided a description of the configuration of driving all the rollers with the single driving source, but the present disclosure is not limited to this configuration. For example, the printer 100 may have a configuration including a plurality of driving sources, such as a configuration with different driving sources for the developing device 121 and the photosensitive drum 122. In this case, the speed correction unit 207 corrects speed with respect to each driving source. This configuration results in identical, effects to those described above. In the configuration including the plurality of driving sources, a correction magnification for each driving source may not be identical. The printer 100 may be configured to adjust a correction amount with respect to each driving source in consideration of influence provided by each driving source on a print operation.

### Second Embodiment

The above-described first embodiment discusses the method of changing the speed of conveyance of paper and expanding and contracting the image to be printed in the conveyance direction to reduce a shift in print position between the pre-printed image printed on pre-printed paper and the image to be printed. In a second embodiment, a configuration in which a post-processing apparatus is connected to the image forming apparatus will be described.

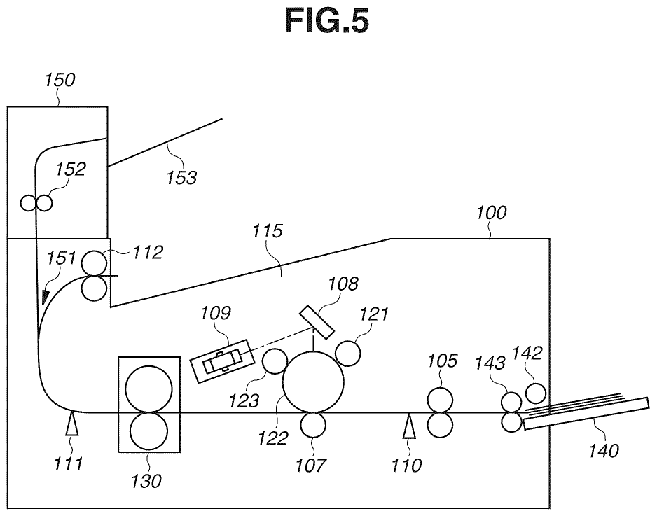

FIG. 5 illustrates a case where a post-processing apparatus 150 for stapling, punching, or the like is connected to the printer 100. In such a case, performing a favorable print operation by merely changing the conveyance speed of the printer 100 as in the first embodiment is impractical

There is a possibility that paper is creased or scratched due to a difference in conveyance speed between a roller driven by the printer 100 (hereinafter referred to as a roller A) and a roller driven by the post-processing apparatus 150 (hereinafter referred to as a roller B) in a period in which the paper is sandwiched by roller A and roller B.

In a case where the conveyance speed of roller A is higher than that of roller B, roller A is brought into a state of pushing the paper, and the paper bends between roller A and roller B. There is a possibility that the paper is scratched by collision of a bent portion of the paper with a member in the post-processing apparatus 150 or the printer 100. The paper may have a fold in it by bending more than a certain amount. In a case where the conveyance speed of roller B is higher than that of roller A, roller B pulls the paper. This can result in the paper being scratched by scraping of roller B or roller A.

A method of performing a favorable print operation in a case where the post-processing apparatus 150 is connected to the printer 100 will now be described.

### <Image Forming Process>

An image forming process according to the second embodiment will be described with reference to FIG. 5. Elements identical to those in the first embodiment are denoted by identical numbers illustrated in FIG. 1, and a description thereof is omitted. The post-processing apparatus 150 is an apparatus that performs post-processing such as stapling processing or punching processing on the paper conveyed from the printer 100.

A paper discharge switching flapper 151 switches between discharge of paper to the paper discharge tray 115 or conveyance of the paper to the post-processing apparatus 150. The post-processing apparatus 150 switches the paper discharge switching flapper 151 depending on whether to perform post-processing on the paper to change a paper conveyance destination. The paper conveyed to the post-processing apparatus 150 is sandwiched and conveyed by reception rollers 152. The paper conveyed by the reception rollers 152 is subjected to stapling processing or punching processing by the post-processing apparatus 150, and thereafter discharged to a second paper discharge tray 153.

### <Hardware Configuration Diagram>

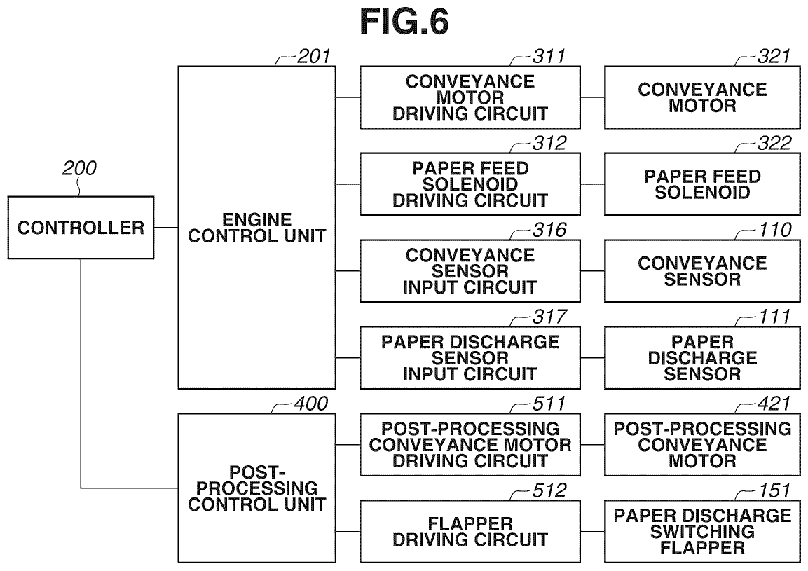

FIG. 6 is a diagram illustrating a hardware configuration of the post-processing apparatus 150 according to the present embodiment. A post-processing control unit 400 operates each driving circuit to control post-processing on paper conveyed from the printer 100. A post-processing conveyance motor 421 is an example of a post-processing drive unit and is driven via a post-processing conveyance motor driving circuit 511. The post-processing conveyance motor 421 rotates the reception rollers 152, which are an example of a post-processing conveyance unit. The paper discharge switching flapper 151 is driven via a flapper driving circuit 512.

The controller 200 communicates with the post-processing control unit 400 via the communication port, which is not illustrated, and provides a notification about various types of information. For example, a size of the recording paper and a type of the recording paper including a thickness of the recording paper and a basis weight of the recording paper is exchanged between the controller 200 and the post-processing control unit 400. The post-processing control unit 400 also communicates with the engine control unit 201 via the controller 200.

### <Control Details>

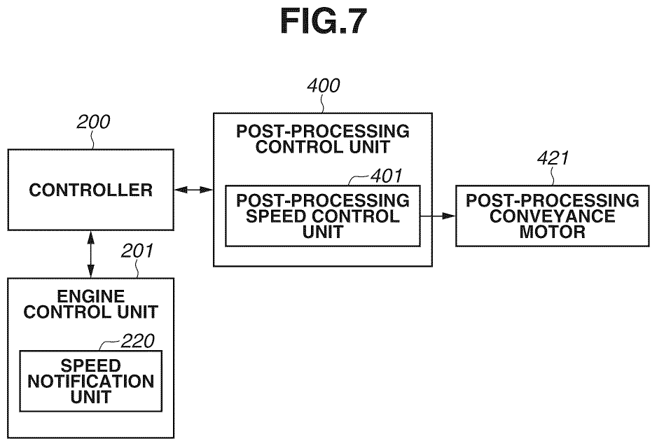

FIG. 7 illustrates a control block diagram according to the present embodiment. The description and illustration of elements that perform processing identical to that in the first embodiment are omitted. The user notifies the controller 200 of a request for performing post-processing such as stapling or punching on print paper via the host computer 203. The controller 200 notifies the post-processing control unit 400 included in the post-processing apparatus 150 of a content of post-processing notified by the user. After issuing the notification about the content of post-processing, the controller 200 provides a print instruction to the engine control unit 201. A speed notification unit 220 notifies the post-processing control unit 400 of speed of conveyance of paper via the controller 200. A post-processing speed control unit 401 switches rotation speed of the post-processing conveyance motor 421 to switch the speed of conveyance of paper by the reception rollers 152. The post-processing control unit 400 uses a stapling control unit and a punching control unit, which are not illustrated, to respectively perform stapling processing and punching processing on conveyed paper.

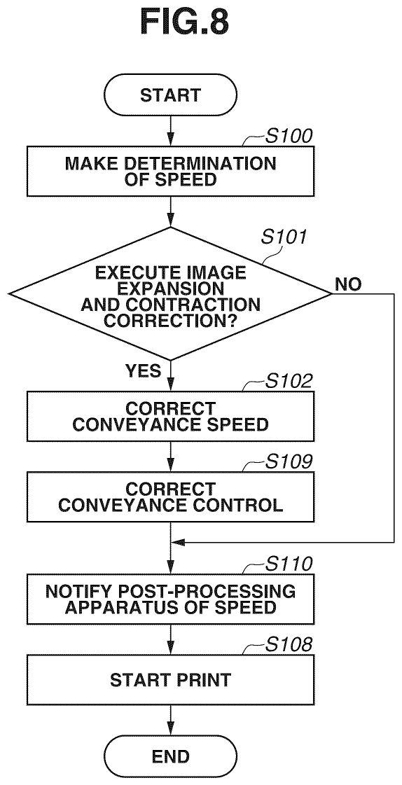

When receiving a print instruction from the controller 200, the engine control unit 201 starts the processing illustrated in a flowchart in FIG. 8. Steps in the flowchart with processing identical to that performed in the first embodiment is denoted by identical reference number, and a description thereof is omitted.

In steps S100 to S102, the speed determination unit 206 and the speed correction unit 207 determine conveyance speed of the printer 100 similarly to the first embodiment. In step S109, the engine control unit 201 corrects conveyance control. Specifically, the engine control unit 201 performs control identical to that in steps S103 to S107 in FIG. 4, and then the processing proceeds to step S110.

In step S110, the speed notification unit 220 notifies the post-processing control unit 400 of the conveyance speed determined in steps S100 to S102 via the controller 200. The post-processing speed control unit 401 rotationally moves the post-processing conveyance motor 421 based on speed notified by the speed notification unit 220. The processing then proceeds to step S108, where the engine control unit 201 starts a print operation.

The paper printed and then fixed by the fixing device 130 by heat is conveyed to reception rollers 152. The reception rollers 152 are rotationally moved at conveyance speed that is equal to that of the fixing device 130. The paper conveyed to the post-processing apparatus 150 is subjected to post-processing such as stapling processing or punching processing, and then discharged to the second paper discharge tray 153.

As described above, according to the present embodiment, in the configuration in which the post-processing apparatus 150 is connected to the printer 100, matching the conveyance speed of the printer 100 and that of the post-processing apparatus 150 with each other enables a favorable print operation that reduces creases and scratches on paper.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-204596, filed Nov. 25, 2024, which is hereby incorporated by reference herein in its entirety.

What is claimed is:

1. An image forming apparatus comprising:
a controller configured to output image information;
an image forming unit configured to form an image on paper based on the image information output from the controller;
a conveyance unit configured to convey the paper to the image forming unit; and
a speed correction unit configured to correct speed of conveyance of the paper by the conveyance unit based on information regarding an expansion and contraction amount of the image.

2. The image forming apparatus according to claim 1, wherein the controller includes a designation unit configured to designate the expansion and contraction amount of the image based on a user instruction, and provide a notification about the designated expansion and contraction amount of the image.

3. The image forming apparatus according to claim 1,
wherein the controller includes a correction enabling unit configured to designate whether to enable correction to expand and contract the image, and
wherein, in a case where the correction enabling unit designates enabling of the correction to expand and contract the image, the controller is configured to provide a notification about information regarding the expansion and contraction amount of the image.

4. The image forming apparatus according to claim 1, further comprising:
a paper feed unit configured to feed paper placed on a loading unit to the image forming unit; and
a paper feed timing control unit configured to, in a case where the speed correction unit corrects the speed of conveyance of the paper, change a timing to feed the paper from the paper feed unit.

5. The image forming apparatus according to claim 1, further comprising an image formation start timing determination unit configured to, in a case where the speed correction unit corrects the speed of conveyance of the paper, determine a timing to start image formation to be instructed to the controller so that a distance between a leading end of the paper in a conveyance direction and a leading end position of an image to be formed on the paper becomes a predetermined distance.

6. The image forming apparatus according to claim 1, further comprising:
a detection unit configured to detect presence or absence of the paper conveyed by the conveyance unit; and
a paper length calculation unit configured to calculate a length of the paper in a conveyance direction based on a period of time in which the detection unit detects the paper,
wherein the paper length calculation unit is configured to, in a case where the speed correction unit corrects the speed of conveyance of the paper, change an expression to be used by the paper length calculation unit.

7. The image forming apparatus according to claim 1, further comprising:
a detection unit configured to detect presence or absence of the paper conveyed by the conveyance unit; and
a paper jam determination unit configured to determine whether a paper jam has occurred based on a result of the detection of the paper,
wherein the paper jam determination unit is configured to, in a case where the speed correction unit corrects the speed of conveyance of the paper, change a timing to determine that the paper jam has occurred.

8. The image forming apparatus according to claim 1, further comprising one or more drive units as driving sources of the conveyance unit.

9. The image forming apparatus according to claim 1, wherein the controller is configured to notify the speed correction unit of image information corresponding to the image.

10. A post-processing apparatus connected to an image forming apparatus including a controller configured to output image information, an image forming unit configured to form an image on paper based on the image information output from the controller, a conveyance unit configured to convey the paper to the image forming unit, and a speed correction unit configured to correct speed of conveyance of the paper by the conveyance unit based on information regarding an expansion and contraction amount of the image, the post-processing apparatus comprising:
a post-processing conveyance unit configured to convey the paper conveyed from the image forming unit;
a post-processing drive unit as a driving source of the post-processing conveyance unit; and
a post-processing control unit configured to control the post-processing drive unit,
wherein the post-processing control unit is configured to, when receiving information regarding corrected speed of conveyance of the paper, the corrected speed being the speed corrected by the speed correction unit, control driving of the post-processing drive unit so that conveyance speed of the post-processing drive unit and conveyance speed of the conveyance unit become equal.
